(19) United States
(12) Patent Application Publication
(10) Pub. No.: US 2012/0291744 A1
(43) Pub. Date: Nov. 22, 2012

(54) SEALING SYSTEM FOR SLIDING SLEEVES FOR CONTROLLING GAS EXCHANGE IN INTERNAL COMBUSTION ENGINES

(75) Inventors: Günter Elsbett, Roth (DE); Otto Daude, Hambuhren (DE)

(73) Assignee: OTTO DAUDE, Hambuhren (DE)

(21) Appl. No.: 13/510,854

(22) PCT Filed: Nov. 16, 2010
(86) PCT No.: PCT/EP10/67578

§ 371 Date: Aug. 2, 2012

(30) Foreign Application Priority Data
Nov. 18, 2009 (DE) 20 2009 017 640.1

(51) Int. Cl. F02F 1/00

(52) U.S. Cl. 123/193.2

(57) ABSTRACT

A sealing system for sliding sleeves for controlling gas exchange in internal combustion engines. The sealing system is designed such that the pressure on the sealing seat of the sliding sleeve increases when the gas pressure increases, which is similar to that of common valves in internal combustion engines. This is obtained by way of a pressure stage on the inner diameter in the region of the sealing seat of the sliding sleeve. As a result, the maximum outer diameter of the sealing seat does not exceed the inner diameter of the piston running surface of the sliding sleeve, the closing pressure acting upon the sliding sleeve being equal to or greater than the maximum possible opening pressure acting upon the sliding sleeve even when the sealing seat is subjected to a total gas pressure.

The invention is suitable in particular for use in opposed piston engines, whose control slits or channels for feeding and discharging the working gas are arranged in the region of the upper piston dead centres. It is known (DE-A-1906542) to control the gas exchange in internal combustion engines by means of sliding sleeves. It is also known (DE202005021624U1 and DE202006020546U1) to avoid a slit overrunning of the pistons in opposed piston engines by means of such sliding sleeves controlling the gas exchange. In this connection arbitrary control times can be achieved in the two-stroke method as well as in the four-stroke methods. Particularly critical in this connection however is a reliable sealing of the sliding sleeves against the gas feed and discharge channels controlled by them, since especially with diesel engines high pressures can occur during the compression and expansion of the working gas.

The known cylinder sealing system for laterally moved pistons by means of piston rings forming a seal against the gas pressure cannot be implemented for spatial reasons however for sliding sleeves. Instead, either an implementation similar to that of a valve can be used, i.e. the sliding sleeve has a cone-shaped sealing seat on its edge controlling the channel opening, or it closes the channel openings by covering them, as in the case of slide valve controls. It is also known from the aforementioned inventions (DE202005021624U1 and DE202006020546U1) to use both sealing methods simultaneously.

The overrunning of the openings by the control edge of the sliding sleeve has the disadvantage that it does not adequately seal them against higher pressures, since the sliding sleeve requires a minimum play in order to ensure its mobility. In addition the covering stretch must be kept short in order to avoid large strokes of the sliding sleeves as well as friction. Due to the inevitably remaining gap a large amount of gas can escape, particularly at low rotational speeds.

The implementation of a sealing front side of a sliding sleeve in the manner of a valve seat with a constant uniform internal diameter differs in its function from conventional valves in that the gas pressure cannot exert a closing force on the sealing surface. On the contrary, if the sealing is not tight over the whole surface, gas that is under pressure can escape into the gap that is formed and thereby enlarge the latter, whereby the sliding sleeve can be subjected to pressure or would at least become less hermetic.

The object of the invention is accordingly to utilise the gas pressure by structural measures as an auxiliary force to keep the sliding sleeves closed.

This is achieved according to the invention by a pressure stage in the internal diameter of the sliding sleeve in the region of the sealing front surface, i.e. the outer sealing diameter is smaller than the pressure-active internal diameter of the sliding sleeve. As a result of this arrangement the sleeve-closing forces are larger than those acting to open the sleeve. Since the sealing seat with the pressure stage is located in the region of the piston top land, when the piston is at the upper dead centre the piston diameter in this region must be smaller than the internal diameter of the sealing seat in order to avoid collision. For practical reasons the sealing seat located in the cylinder can be designed so as to be replaceable. As in conventional valve seats, a highly suitable material can be used for this purpose.

Comparable to the case of conventional bi-metallic valves with different valve shaft and valve disc materials, a more suitable material different from the basic material can be used in the sealing region of the control sleeve. Whereas a conventional cylinder sleeve material with good sliding properties is conveniently used in the sliding part and is coated in the region of the pistons and piston rings, the sliding sleeve in the region of its sealing surface can be made of a high strength and thermally resistant material. As with conventional valves the various materials can be joined by friction welding, electron beam welding or other suitable joining methods. The advantage of this implementation with different materials is a higher strength and thermal loadability.

### DESCRIPTION OF THE FIGURES

FIG. 1 shows a cross-section through an opposed piston engine. Two pistons 1 and 2 move counter to one another in an engine housing consisting of two crank housings 3 and 4 and two cylinder halves 5 and 6 that are connected to one another by a cylinder middle part 7. The pistons are driven by two crankshafts 8 and 9, as well as by the connecting rods 10 and 11. Their movement is synchronised by means of a gear drive 12. The pistons run in the sliding sleeves 13 and 14, which in turn are displacably guided in the cylinder halves 5 and 6. Due to their displacement the annular gas channel 15 and 16 can be opened and closed independently of one another.

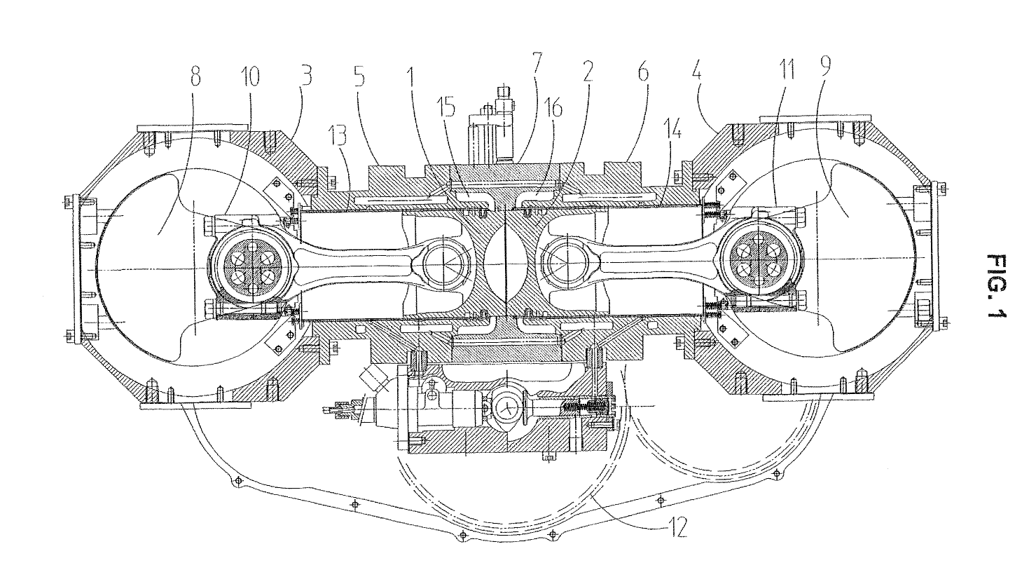

FIG. 2 shows the details of the aforementioned cross-section in the region of the sealing of the sliding sleeves 13 and 14. The sliding sleeve 13 is illustrated in the open state and the sliding sleeve 14 in the closed state. The sealing seat for the sliding sleeves is installed in the cylinder middle part 7 and is formed as a cone-shaped sealing seat 15 and 16, on which abuts in the closed state the cone-shaped sealing surface applied respectively to the sealing end of the sliding sleeves. The gas pressure that also prevails in the sliding sleeve during the operating stroke respectively charges the annular surface that is formed by the internal diameter 17 of the sliding sleeve and the internal diameter 18 of the sealing seat. This pressure forces the sliding sleeves against the seat. In the closed state the sealing end of the sliding sleeve drives a short part into a fit 19, which serves to support the sealing end of the sliding sleeve and is prevented from cracking by high gas pressures. A precondition for correct functioning is that the outer diameter of the sealing seat is not larger than the internal diameter of the sliding sleeve, and that the space behind the sealing seat is sufficiently ventilated so that in the case of a seat that is not hermetically sealed no pressure can build up there. Local grooves 20, formed at some points on the circumference of the fit 19, serve for the purpose of ventilation.

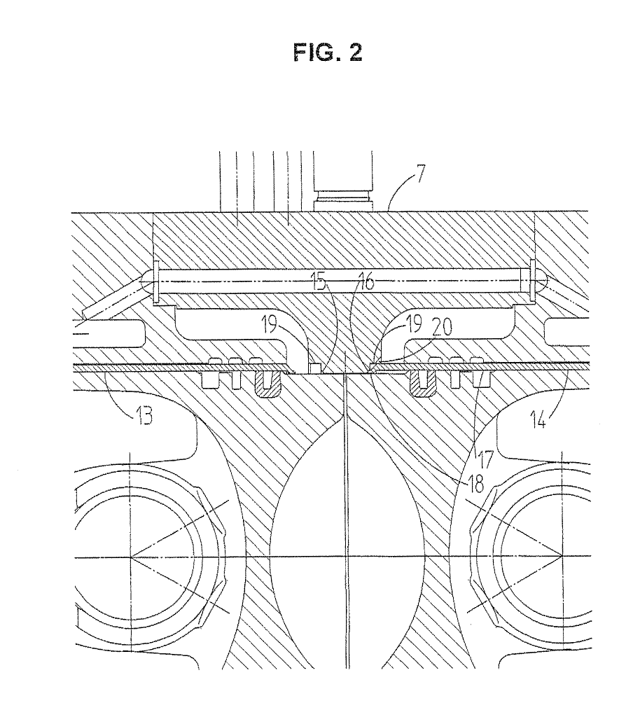

FIG. 3 shows an example of a replaceable seating ring 21, which is held by the flange 22 and 23, which in turn is secured by means of the screws 24. This embodiment has the advantage that an optimally suitable material can be chosen for the seating ring 21, independently of the material of the cylinder middle part 7. It has also been shown that the front face of the sliding sleeve comprising sealing surfaces can be formed as a separate material-optimised part 25, which is securely joined to the sliding sleeve.

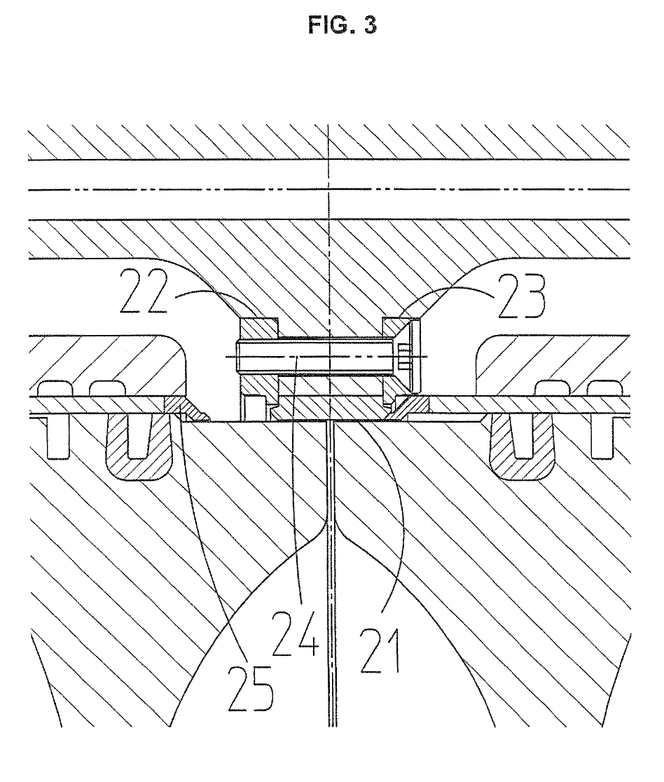

1. A sealing system for sliding sleeves for controlling gas exchange in internal combustion engines, wherein the sliding sleeve has a step-shaped sealing region on a sealing front side thereof, the sealing region formed so that the external diameter of a sealing seat is the same as or smaller than the internal diameter of the sliding sleeve serving as piston guide.

2. The sealing system for sliding sleeves according to claim 1, wherein the sealing seat is cone-shaped.

3. The sealing system for sliding sleeves according to claim 1, wherein the sealing seat installed in the cylinder, on which the sliding sleeves sit in the closed state, is designed to be replaceable.

4. The sealing system for sliding sleeves according to claim 1, wherein the sealing seat installed in the cylinder, on which the sliding sleeves sit in the closed state, is made of a material different to that of the cylinder and suitable for its functional purpose.

5. The sealing for sliding sleeves according to claim 1, wherein the sliding sleeve in the region of its sealing surface is made of another material appropriately adapted to its functional purpose.

6. The sealing for sliding sleeves according to claim 5, wherein the part of the sliding sleeve consisting of another material is securely joined thereto by electron beam welding or laser welding.
